(19) United States
(12) Patent Application Publication
(10) Pub. No.: US 2026/0234463 A1
(43) Pub. Date: Aug. 13, 2026

(54) RECOVERABLE ORGANIC-INORGANIC HYBRID NANOPARTICLES, GAS HYDRATE INHIBITOR HAVING THE SAME, AND PREPARING METHOD THEREOF

(71) Applicant: GWANGJU INSTITUTE OF SCIENCE AND TECHNOLOGY, Gwangju (KR)

(72) Inventors: Young June PARK, Gwangju (KR); Seung In LEE, Gwangju (KR); Yun Seok LEE, Gwangju (KR)

(21) Appl. No.: 19/263,400

(22) Filed: Jul. 8, 2025

(30) Foreign Application Priority Data
Feb. 10, 2025 (KR) 10-2025-0016838

(51) Int. Cl. C09K 8/52

(52) U.S. Cl. CPC C09K 8/52; C09K 2208/22

(57) ABSTRACT

Disclosed are recoverable organic-inorganic hybrid nanoparticles, a gas hydrate inhibitor having the same, and a method for preparing the same. The recoverable organic-inorganic hybrid nanoparticles include magnetic nanoparticles, silica coated on surface of the magnetic nanoparticles and having hydroxyl groups at terminal ends, and an organosilyl sulfonic acid bonded to the hydroxyl groups of the silica through a hydrolysis reaction. The iron oxide-based nanostructured gas hydrate inhibitor is effective at a low dosage and can be magnetically recovered.

### CROSS-REFERENCE TO RELATED PATENT APPLICATION

This application claims the benefit of Korean Patent Application No. 10-2025-0016838, filed on Feb. 10, 2025, in the Korean Intellectual Property Office, the disclosure of which is incorporated herein in its entirety by reference.

### BACKGROUND

### 1. Field of the Inventive Concept

The present inventive concept relates to recoverable organic-inorganic hybrid nanoparticles, a gas hydrate inhibitor having the same, and a method for preparing the same. More particularly, the present inventive concept relates to a kinetic gas hydrate inhibitor which utilizes an iron oxide-based nanostructure, is effective at a low dosage, and can be magnetically recovered.

### 2. DESCRIPTION OF THE RELATED ART

Natural gas is transported through pipelines in the form of multiphase flow consisting of gas and water during subsea transportation.

During this process, the combination of low-temperature conditions in subsea environments, high-pressure conditions in transport pipelines, and the presence of natural gas mixtures (such as methane, ethane and propane) may lead to crystal formation within the pipelines, which can obstruct gas flow or lead to pipeline blockage.

Gas hydrates, also referred to as clathrate hydrates, are crystalline inclusion compounds formed under specific low-temperature and high-pressure conditions through interactions between water molecules (hosts) and gaseous molecules (guests).

That is, the moisture contained in the transported natural gas forms hydrogen bonds with gaseous molecules (such as methane, ethane and propane), and the gaseous molecules become trapped within host cage structures formed by the water molecules.

This can hinder the efficient transportation of natural gas through pipelines. Accordingly, it is of great importance to inhibit the formation of gas hydrates in order to maintain flow assurance within the pipeline.

Conventionally, methods such as thermal insulation of pipelines, water removal, or the application of heat sources have been employed to prevent the formation of gas hydrates. However, such treatment methods require significant costs and resources, and thus, there is a need for an economical solution.

As an alternative approach to address the above-mentioned problems, the development of gas hydrate inhibitors has been actively pursued. Such inhibitors are generally classified into thermodynamic hydrate inhibitors (THIs) and kinetic hydrate inhibitors (KHIs).

Thermodynamic hydrate inhibitors inhibit the formation of gas hydrates by shifting the thermodynamic phase equilibrium conditions required for hydrate formation to lower temperatures and higher pressures. However, this approach requires high dosages of inhibitors and necessitates the installation of storage and regeneration facilities, thereby incurring additional costs.

Kinetic hydrate inhibitors kinetically inhibit hydrate formation by delaying the nucleation and growth rates of gas hydrates. This approach is effective at relatively low dosages and is attracting attention as an economical and efficient alternative.

Certain kinetic hydrate inhibitors are known not to satisfy the biodegradability requirements specified in marine regulations (e.g., OECD 306 test). Accordingly, there is a need for the development of environmentally friendly kinetic hydrate inhibitors.

The present inventive concept aims to provide a solution that not only ensures the stability of natural gas transportation systems but also reduces environmental burdens.

### SUMMARY OF THE INVENTIVE CONCEPT

The present inventive concept has been made in an effort to solve the above-described problems associated with prior art, and a first object of the present inventive concept is to provide recoverable organic-inorganic hybrid nanoparticles.

A second object of the present inventive concept is to provide a gas hydrate inhibitor using the recoverable organic-inorganic hybrid nanoparticles acquired by the first object, which is effective at a low dosage and can be magnetically recovered.

A third object of the present inventive concept is to provide a method for preparing the recoverable organic-inorganic hybrid nanoparticles for achieving the first object.

In order to achieve the first object, the present inventive concept provides recoverable organic-inorganic hybrid nanoparticles.

The recoverable organic-inorganic hybrid nanoparticles may comprise: magnetic nanoparticles; silica coated on surface of the magnetic nanoparticles and having hydroxyl groups at terminal ends; and an organosilyl sulfonic acid bonded to the hydroxyl groups of the silica through a hydrolysis reaction.

The magnetic nanoparticles may be Fe₃O₄ nanoparticles.

The organosilyl sulfonic acid may be selected from the group consisting of 3-(trihydroxysilyl) propanesulfonic acid, 3-(trimethoxysilyl)propanesulfonic acid, 3-(triethoxysilyl) propanesulfonic acid, and 4-(trimethoxysilyl)phenylmethanesulfonic acid.

In order to achieve the second object, the present inventive concept provides a gas hydrate inhibitor.

The gas hydrate inhibitor may comprise: recoverable organic-inorganic hybrid nanoparticles comprising magnetic nanoparticles, silica coated on surface of the magnetic nanoparticles and having hydroxyl groups at terminal ends, and an organosilyl sulfonic acid bonded to the hydroxyl groups of the silica through a hydrolysis reaction; and amine-terminated poly(N-isopropylacrylamide), wherein hydroxyl groups of the organosilyl sulfonic acid and amine groups of the amine-terminated poly(N-isopropylacrylamide) form ionic bonding.

The magnetic nanoparticles may be Fe₃O₄ nanoparticles.

The organosilyl sulfonic acid may be selected from the group consisting of 3-(trihydroxysilyl) propanesulfonic acid, 3-(trimethoxysilyl) propanesulfonic acid, 3-(triethoxysilyl) propanesulfonic acid, and 4-(trimethoxysilyl)phenylmethanesulfonic acid.

The gas hydrate inhibitor may be suspended in water at a concentration of 0.25 wt % to 3 wt %.

In order to achieve the third object, the present inventive concept provides a method for preparing recoverable organic-inorganic hybrid nanoparticles.

The method for preparing recoverable organic-inorganic hybrid nanoparticles may comprise the steps of: synthesizing silica-coated magnetic nanoparticles; dispersing the silica-coated magnetic nanoparticles in an aqueous solution to prepare a suspension; adding an organosilyl sulfonic acid to the suspension; adjusting pH of the suspension to which the organosilyl sulfonic acid has been added; dialyzing the pH-adjusted suspension; and treating the dialyzed suspension with a cation exchange resin.

The step of synthesizing the silica-coated magnetic nanoparticles may comprise the steps of: activating hydroxyl groups on surface of the magnetic nanoparticles; adding ethanol, deionized water, and ammonia water to the magnetic nanoparticles having the activated hydroxyl groups, followed by a first ultrasonic treatment; and adding a silica precursor and ethanol to the magnetic nanoparticles subjected to the first ultrasonic treatment, followed by a second ultrasonic treatment.

The activating hydroxyl groups has dispersing the magnetic nanoparticles in deionized water and performing a third ultrasonic treatment for the dispersed magnetic nanoparticles while introducing nitrogen (N₂).

The silica precursor may be tetraethyl orthosilicate (TEOS).

The magnetic nanoparticles may be Fe₃O₄ nanoparticles.

The organosilyl sulfonic acid may be selected from the group consisting of 3-(trihydroxysilyl)propanesulfonic acid, 3-(trimethoxysilyl)propanesulfonic acid, 3-(triethoxysilyl)propanesulfonic acid, and 4-(trimethoxysilyl)phenylmethanesulfonic acid.

The pH may be adjusted to 4.5 to 5.5.

According to the present inventive concept, there are provided recoverable organic-inorganic hybrid nanoparticles, a gas hydrate inhibitor having the same, and a method for preparing the same. Through this, it is possible to provide a kinetic gas hydrate inhibitor which utilizes an iron oxide-based nanostructure, is effective at a low dosage, and can be magnetically recovered.

### BRIEF DESCRIPTION OF THE DRAWINGS

FIG. 1 is a schematic diagram illustrating the synthesis process of a gas hydrate inhibitor according to an embodiment of the present inventive concept.

FIG. 2 shows the results of the ATR FT-IR analysis according to the Preparation Examples of the present inventive concept and Comparative Example.

FIG. 3 shows the results of the XPS analysis for identifying the chemical states of surface elements (Fe, O, Si, and C) according to the Preparation Examples of the present inventive concept and Comparative Example.

FIG. 4 shows the results of the XPS analysis for identifying the chemical states of surface elements (O, Si, C, and N) according to the Preparation Examples of the present inventive concept.

FIG. 5 is a graph showing the onset temperatures of hydrate formation for pure natural gas and the inhibitors according to the Preparation Examples of the present inventive concept.

FIG. 6 is a graph evaluating the long-term kinetic inhibition performance of the gas hydrate inhibitor prepared according to an embodiment of the present inventive concept.

FIG. 7 shows that the gas hydrate inhibitor prepared according to an embodiment of the present inventive concept can be magnetically recovered.

### DETAILED DESCRIPTION OF THE INVENTIVE CONCEPT

Hereinafter, preferred embodiments of the present inventive concept will be described in more detail with reference to the accompanying drawings in order to provide a more specific description of the inventive concept. However, the present inventive concept is not limited to the embodiments described herein and may be embodied in other forms.

Throughout this specification, when a part is referred to as “including” a certain component, it is to be understood that, unless explicitly stated otherwise, the part may further include other components and does not exclude the presence of other components.

It will be understood that, when an element such as a layer, region, or substrate is referred to as being “on” another element, the element may be directly on the other element or may have one or more intervening elements there between.

It will be understood that, although the terms “first”, “second”, and the like may be used herein to describe various elements, components, regions, layers, and/or sections, such elements, components, regions, layers, and/or sections should not be limited by these terms.

Hereinafter, embodiments of the present inventive concept will be described in more detail with reference to the accompanying drawings.

### EMBODIMENT

One aspect of the present inventive concept provides recoverable organic-inorganic hybrid nanoparticles comprising: magnetic nanoparticles; silica coated on surface of the magnetic nanoparticles and having hydroxyl groups at terminal ends; and an organosilyl sulfonic acid bonded to the hydroxyl groups of the silica through a hydrolysis reaction.

First, hydroxyl groups are introduced onto the surface of magnetic nanoparticles, and the surface of the magnetic nanoparticles is coated with silica using tetraethyl orthosilicate (TEOS) as a silica precursor.

Subsequently, an organosilyl sulfonic acid is added to induce a hydrolysis reaction between the hydroxyl groups on the surface of the magnetic nanoparticles and the organosilyl sulfonic acid, thereby bonding the organosilyl sulfonic acid to the silica-coated magnetic nanoparticles.

A more detailed description will be provided below in the description of the method for preparing recoverable organic-inorganic hybrid nanoparticles.

Another aspect of the present inventive concept provides a gas hydrate inhibitor comprising: recoverable organic-inorganic hybrid nanoparticles comprising magnetic nanoparticles, silica coated on surface of the magnetic nanoparticles and having hydroxyl groups at terminal ends, and an organosilyl sulfonic acid bonded to the hydroxyl groups of the silica through a hydrolysis reaction; and amine-terminated poly(N-isopropylacrylamide), wherein hydroxyl groups of the organosilyl sulfonic acid and amine groups of the amine-terminated poly(N-isopropylacrylamide) form ionic bonding.

Next, an amine-terminated poly(N-isopropylacrylamide) is added to the recoverable organic-inorganic hybrid nanoparticles to form ionic bonding between the hydroxyl groups of the organosilyl sulfonic acid and amine groups of the amine-terminated poly(N-isopropylacrylamide), thereby preparing a gas hydrate inhibitor.

A more detailed description will be provided below in the description of a method for preparing a gas hydrate inhibitor.

The method for preparing recoverable organic-inorganic hybrid nanoparticles according to another aspect of the present inventive concept will be described in detail below.

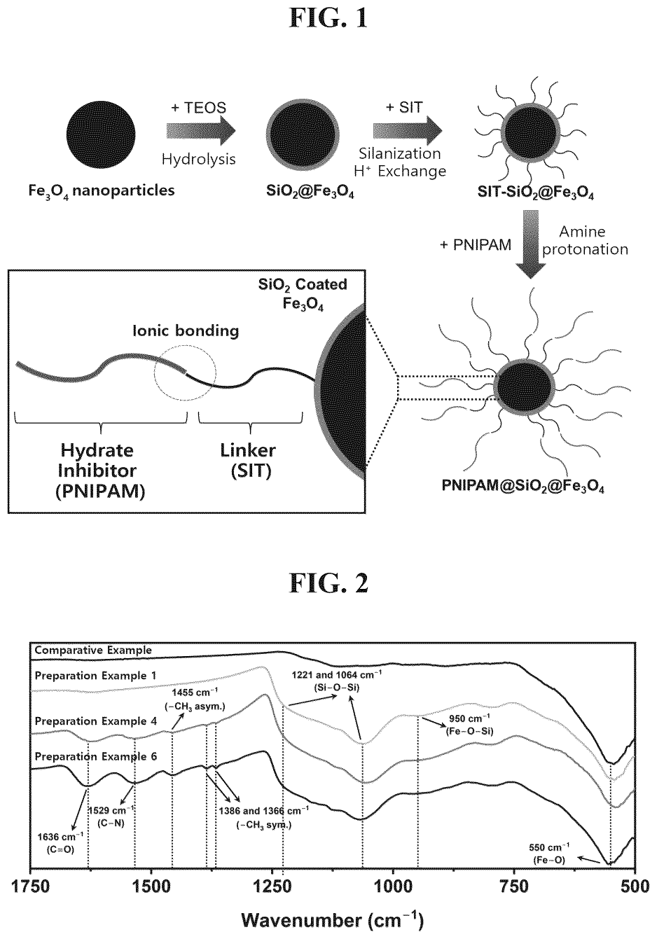

FIG. 1 is a schematic diagram illustrating the synthesis process of a gas hydrate inhibitor according to an embodiment of the present inventive concept.

Referring to FIG. 1, the synthesis process of silica-coated magnetic nanoparticles will be described.

The step of synthesizing the silica-coated magnetic nanoparticles may comprise the steps of: activating hydroxyl groups on surface of the magnetic nanoparticles; adding ethanol, deionized water, and ammonia water to the magnetic nanoparticles having the activated hydroxyl groups, followed by a first ultrasonic treatment; and adding a silica precursor and ethanol to the magnetic nanoparticles subjected to the first ultrasonic treatment, followed by a second ultrasonic treatment.

Specifically, activating hydroxyl groups has dispersing the magnetic nanoparticles in deionized water and performing a third ultrasonic treatment for the dispersed magnetic nanoparticles while introducing nitrogen (N₂). Preferably, the magnetic nanoparticles are Fe₃O₄ nanoparticles. Furthermore, the N₂ gas is used as purging gas.

The third ultrasonic treatment may be performed at a frequency of 40 kHz for 5 minutes.

Subsequently, ethanol, deionized water, and ammonia water are to the magnetic nanoparticles having activated hydroxyl groups, followed by a first ultrasonic treatment. The first ultrasonic treatment may be performed at a frequency of 40 kHz for 10 minutes.

Subsequently, a silica precursor and ethanol are added to the magnetic nanoparticles subjected to the first ultrasonic treatment, followed by a second ultrasonic treatment to prepare silica-coated magnetic nanoparticles. Preferably, the silica precursor is tetraethyl orthosilicate (TEOS).

Preferably, the magnetic nanoparticles subjected to the first ultrasonic and the silica precursor are added at a mass ratio of 1:3.41.

The second ultrasonic treatment may be performed at a frequency of 40 kHz for 30 minutes.

As described above, once the hydroxyl groups on the surface of the magnetic nanoparticles are activated, silica is coated on the surface of the magnetic nanoparticles through a hydrolysis reaction with the silica precursor, and hydroxyl groups are formed on the outer surface of the silica during this process.

Next, referring to FIG. 1, the synthesis process of recoverable organic-inorganic hybrid nanoparticles will be described.

The method for preparing recoverable organic-inorganic hybrid nanoparticles may comprise the steps of: synthesizing silica-coated magnetic nanoparticles; dispersing the silica-coated magnetic nanoparticles in an aqueous solution to prepare a suspension; adding an organosilyl sulfonic acid to the suspension; adjusting pH of the suspension to which the organosilyl sulfonic acid has been added; dialyzing the pH-adjusted suspension; and treating the dialyzed suspension with a cation exchange resin.

Specifically, for silanization of the surface of the silica-coated magnetic nanoparticles, the nanoparticles are dispersed in an aqueous solution, followed by the addition of an organosilyl sulfonic acid.

In this process, the organosilyl sulfonic acid is bonded to the surface of the silica-coated magnetic nanoparticles through a hydrolysis reaction with the hydroxyl groups on the outer surface of the silica.

The organosilyl sulfonic acid may be selected from the group consisting of 3-(trihydroxysilyl)propanesulfonic acid, 3-(trimethoxysilyl) propanesulfonic acid, 3-(triethoxysilyl)propanesulfonic acid, and 4-(trimethoxysilyl)phenylmethanesulfonic acid. Preferably, the organosilyl sulfonic acid is 3-(trihydroxysilyl) propanesulfonic acid (SIT).

The hydroxyl groups present at the terminal and intermediate positions of the organosilyl sulfonic acid may be bonded to metal ions and thus can be used as a precipitant. In particular, since the core consists of magnetic nanoparticles, the resulting precipitant can be easily recovered.

Subsequently, a base is added to adjust the pH to 4.5 to 5.5. Preferably, the base is sodium hydroxide.

After allowing the reaction to proceed for a sufficient time, dialysis is performed to remove unreacted excess organosilyl sulfonic acid.

After dialysis, sodium ions (Na⁺) are removed using a cation exchange resin.

By using a cation exchange resin, impurities contained in the solution can be removed together with the solution, while only the silica-coated magnetic nanoparticles bonded with the organosilyl sulfonic acid can be selectively retained.

Still another aspect of the present inventive concept provides a method for preparing a gas hydrate inhibitor.

Referring to FIG. 1, the synthesis process of a gas hydrate inhibitor will now be described.

The synthesis process may comprise the steps of obtaining the organic-inorganic hybrid nanoparticles prepared according to the above-described method, and adding the nanoparticles to an aqueous solution of amine-terminated poly(N-isopropylacrylamide).

Specifically, an aqueous solution of poly(N-isopropylacrylamide) having amine groups at the terminal ends is added to the silica-coated magnetic nanoparticles, to which an organosilyl sulfonic acid is bonded and which are dispersed in deionized water, thereby preparing silica-coated magnetic nanoparticles onto which the amine-terminated poly(N-isopropylacrylamide) is grafted and to which the organosilyl sulfonic acid is bound.

Poly(N-isopropylacrylamide) (PNIPAM) is a water-soluble polymer, and the —NH₂ functional group bonded to the amine-terminated poly(N-isopropylacrylamide) can form an ionic bonding with the —OH group of the organosilyl sulfonic acid.

As a result, the —NH₂ functional group of the amine-terminated poly(N-isopropylacrylamide) is protonated to form —NH₃⁺, and the organosilyl sulfonic acid serves as a linker connecting the silica-coated magnetic nanoparticles and the amine-terminated poly(N-isopropylacrylamide).

The inhibitor may be suspended in water at a concentration of 0.25 wt % to 3 wt %. Therefore, the inhibitor is effective in that it is used at a lower dosage than thermodynamic hydrate inhibitors, which require high dosages of 20 wt % to 60 wt %.

Next, preferred Preparation Examples and Measurement Examples are provided to facilitate understanding of the present inventive concept. However, these examples are presented for illustrative purposes only and are not intended to limit the scope of the present inventive concept.

### Preparation Example 1: Preparation of Silica-Coated Fe₃O₄ Nanoparticles

Fe₃O₄ nanoparticles 5 g were dispersed in 500 mL of deionized water, and nitrogen (N₂) gas as purging gas was introduced while ultrasonic treatment was applied for 5 minutes using a sonicator (WUC-D10H, Daihan Scientific Co., Ltd., Republic of Korea) to activate the hydroxyl groups on the surface of the Fe₃O₄ nanoparticles.

After discarding the deionized water used for the ultrasonic treatment, 250 ml of ethanol, 31.25 mL of deionized water, and 12.5 mL of ammonia water were added, followed by ultrasonic treatment for 10 minutes.

Subsequently, 15.92 mL of tetraethyl orthosilicate and 250 ml of ethanol were added, followed by ultrasonic treatment for 30 minutes. The resulting product was then washed with deionized water to prepare silica-coated Fe₃O₄ nanoparticles.

### Preparation Example 2: Preparation of Silica-Coated Fe₃O₄ Nanoparticles Bonded with Organosilyl Sulfonic Acid

Silica-coated Fe₃O₄ nanoparticles 2 g prepared in Preparation Example 1 was dispersed in a 3 wt % aqueous solution.

The dispersion of silica-coated Fe₃O₄ nanoparticle was added to a 6 wt % aqueous solution of 3-(trihydroxysilyl) propanesulfonic acid (SIT).

Subsequently, a 1 M aqueous solution of sodium hydroxide was added, and the pH was adjusted to 5 using a pH meter (S220, Mettler-Toledo International Inc., Switzerland). The mixture was then stirred and allowed to react in a heating bath at 343.15 K for 24 hours.

In order to remove the unreacted excess 3-(trihydroxysilyl) propanesulfonic acid, the reaction mixture was placed in a dialysis tube (3.5 K MWCO SnakeSkin™ Dialysis Tubing) and dialyzed for 48 hours while periodically replacing the deionized water.

Subsequently, sodium ions (Na⁺) were removed using a cation exchange resin (AmberLite™ HPR2900 H hydrogen form), thereby preparing silica-coated Fe₃O₄ nanoparticles bonded with organosilyl sulfonic acid.

### Preparation Example 3: Preparation of 1 wt % Gas Hydrate Inhibitor with 50% Grafting of Amine-Terminated Poly(N-Isopropylacrylamide)

The silica-coated Fe₃O₄ nanoparticles bonded with organosilyl sulfonic acid, prepared in Preparation Example 2, were dispersed in 40 mL of deionized water.

Then, 3.0 mL of a 5 wt % aqueous solution of amine-terminated poly(N-isopropylacrylamide) (PNIPAM; Mn=5,500 g/mol) was added, and the mixture was dried in an oven (OF-02GW, Jeio Tech Co., Ltd., Republic of Korea) at 333.15 K for 24 hours.

Subsequently, the mixture was gently ground using a mortar and pestle to prepare a gas hydrate inhibitor in which amine-terminated poly(N-isopropylacrylamide) was grafted at a rate of 50%.

The resulting inhibitor was suspended in water at a concentration of 1 wt %.

### Preparation Example 4: Preparation of 2 wt % Gas Hydrate Inhibitor with 50% Grafting of Amine-Terminated Poly(N-Isopropylacrylamide)

A gas hydrate inhibitor was prepared in the same manner as in Preparation Example 3, except that the inhibitor was suspended in water at a concentration of 2 wt %.

### Preparation Example 5: Preparation of 1 wt % Gas Hydrate Inhibitor with 100% Grafting of Amine-Terminated Poly(N-Isopropylacrylamide)

The silica-coated Fe₃O₄ nanoparticles bonded with organosilyl sulfonic acid, prepared in Preparation Example 2, were dispersed in 40 mL of deionized water.

Then, 6.0 mL of a 5 wt % aqueous solution of amine-terminated poly(N-isopropylacrylamide) was added, and the mixture was dried in an oven at 333.15 K for 24 hours.

Subsequently, the mixture was gently ground using a mortar and pestle to prepare a gas hydrate inhibitor in which amine-terminated poly(N-isopropylacrylamide) was grafted at a rate of 100%.

The resulting inhibitor was suspended in water at a concentration of 1 wt %.

### Preparation Example 6: Preparation of 2 wt % Gas Hydrate Inhibitor with 100% Grafting of Amine-Terminated Poly(N-Isopropylacrylamide)

A gas hydrate inhibitor was prepared in the same manner as Preparation Example 5, except that the inhibitor was suspended in water at a concentration of 2 wt %.

### Comparative Example: Fe₃O₄ Nanoparticles

Fe₃O₄ nanoparticles purchased from Sigma-Aldrich Co. (USA) were prepared.

### Measurement Example 1: Structural Analysis of Gas Hydrate Inhibitors

FIG. 2 shows the results of the ATR FT-IR analysis according to the Preparation Examples of the present inventive concept and Comparative Example.

To verify the chemical bonding and vibrational states of the samples prepared in the Comparative Example and Preparation Examples 1, 4 and 6, a Fourier transform infrared (FT-IR) spectrometer (Spectrum Two, PerkinElmer Inc., USA) equipped with an attenuated total reflection (ATR) accessory with a diamond crystal and a deuterated triglycine sulfate (DTGS) detector was used.

Referring to FIG. 2, a peak at 550 cm⁻¹ corresponding to the Fe—O stretching vibration of Fe₃O₄ was observed in all samples.

Moreover, a peak at 950 cm⁻¹ corresponding to the Fe—O—Si stretching vibration, and peaks at 1064 cm⁻¹ and 1221 cm⁻¹ corresponding to the Si—O—Si asymmetric stretching vibrations were observed in the samples of Preparation Examples 1, 4 and 6. These results indicate that silica was successfully coated on the surface of Fe₃O₄.

In the samples of Preparation Examples 4 and 6, peaks were observed at 1366 cm⁻¹ and 1386 cm⁻¹, which correspond to the —CH₃ symmetric stretching vibrations in the amine-terminated poly(N-isopropylacrylamide). Furthermore, a peak was observed at 1455 cm⁻¹, which corresponds to the —CH₃ asymmetric stretching vibration.

The peaks at 1529 cm⁻¹ and 1636 cm⁻¹, which correspond to the C—N and C═O stretching vibrations of the amide functional group in the amine-terminated poly(N-isopropylacrylamide), were more prominent in Preparation Example 6 than in Preparation Example 4, suggesting that the grafting density was higher in Preparation Example 6.

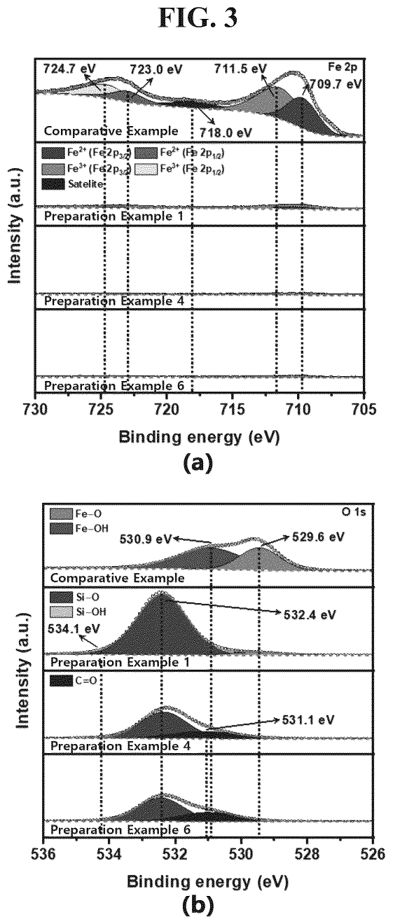

FIG. 3 shows the results of the XPS analysis for identifying the chemical states of surface elements (Fe, O, Si, and C) according to the Preparation Examples of the present inventive concept and Comparative Example.

To identify the chemical states of the surface elements (Fe, O, Si, C, and N) in the Comparative Example and Preparation Examples 1, 4 and 6, X-ray photoelectron spectroscopy (XPS, NEXSA, Thermo Fisher Scientific, USA) equipped with a monochromatic, micro-focused Al Kα X-ray source was used.

Referring to FIG. 3(a), the Fe 2p XPS spectra of the FesO₄ nanoparticles in the Comparative Example exhibited distinct Fe²⁺ and Fe³⁺ peaks at 709.7 eV, 711.5 eV, 723.0 eV, and 724.7 eV, along with a satellite peak at 718.0 eV, indicating the characteristic Fe content of Fe₃O₄.

The XPS spectra of the nanoparticles in Preparation Example 1 showed a significant decrease in peak intensity, confirming that the silica coating was effectively formed. This tendency was even more pronounced in Preparation Examples 4 and 6.

Referring to FIG. 3(b), the O 1s spectrum of the Fe₃O₄ nanoparticles in the Comparative Example exhibits Fe—O and Fe—OH peaks at 529.6 eV and 530.9 eV, respectively. In contrast, the nanoparticles in the Preparation Example 1 show Si—O and Si—OH peaks at 532.4 eV and 534.1 eV, respectively, indicating that silica was successfully coated on the Fe₃O₄ nanoparticles.

In addition, the O 1s spectrum of the samples from Preparation Examples 4 and 6 exhibited a C═O peak at 531.1 eV, confirming the presence of an amide functional group.

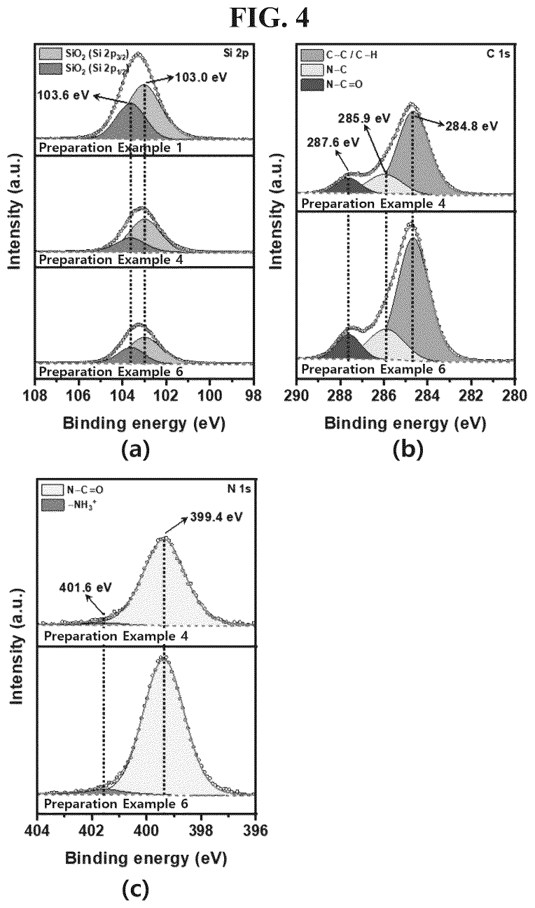

FIG. 4 shows the results of the XPS analysis for identifying the chemical states of surface elements (O, Si, C, and N) according to the Preparation Examples of the present inventive concept.

Referring to FIG. 4(a), the Si 2p spectrum of the sample from Preparation Example 1 exhibited Si 2p_{3/2} and Si 2p_{1/2} peaks at 103.0 eV and 103.6 eV, respectively.

In contrast, the samples from Preparation Examples 4 and 6 exhibited slightly reduced peak intensities, indicating that the amine-terminated poly(N-isopropylacrylamide) was bonded to the silica surface.

Referring to FIG. 4(b), the C 1s spectrum confirms the presence of peaks at 284.8 eV, 285.9 eV, and 287.6 eV, which correspond to the C—C/C—H, N—C, and N—C═O bonds of the amine-terminated poly(N-isopropylacrylamide), respectively.

The C—C/C—H peaks originates from the C—C and C—H bonds present in both the 3-(trihydroxysilyl) propanesulfonic acid and the amine-terminated poly(N-isopropylacrylamide), indicating that the 3-(trihydroxysilyl) propanesulfonic acid plays an important role as a linker connecting the silica-coated Fe₃O₄ nanoparticles and the amine-terminated poly(N-isopropylacrylamide).

The N—C peak corresponds to both the N—C bond of the amine group attached to the amine-terminated poly(N-isopropylacrylamide) and the N—C bond within the poly(N-isopropylacrylamide).

The N—C—O peak is associated with the presence of an amide functional group, indicating that the amine-terminated poly(N-isopropylacrylamide) plays an important role in kinetic inhibition.

Referring to FIG. 4(c), the N 1s spectrum exhibits a peak at 399.4 eV corresponding to the N—C═O bond of the amine-terminated poly(N-isopropylacrylamide) and a peak at 401.6 eV corresponding to the —NH₃⁺ group.

The —NH₂ functional group bonded to the amine-terminated poly(N-isopropylacrylamide) can form ionic bonding with the —OH group of the 3-(trihydroxysilyl) propanesulfonic acid, and the amine group of the grafted amine-terminated poly(N-isopropylacrylamide) is protonated to form —NH₃⁺.

### Measurement Example 2: Evaluation of Kinetic Inhibition Performance of the Gas Hydrate Inhibitors

To evaluate the kinetic inhibition performance of the gas hydrate inhibitors prepared according to the Preparation Examples of the present inventive concept, the onset temperature was measured with respect to the cooling rate.

Specifically, the gas hydrate inhibitors prepared in Preparation Example 3 to 6 were each dispersed in deionized water to prepare 10 g suspension.

The resulting suspensions were then introduced into a high-pressure reactor made of 316-grade stainless steel with an internal volume of 50 mL.

To simulate natural gas, a mixture of CH₄ 90%, C₂H₆ 7%, and C₃H₈ 3% was introduced and pressurized to 10.0 MPa at 293.15 K, followed by cooling.

During the cooling step, the “rapid” (R) condition was performed at a cooling rate of 10 K per hour, and the “slow” (S) condition at 1 K per hour, with the temperature gradually lowered to 273.15 K.

Under the same cooling rate, the point where a sudden pressure drop occurred was designated as the hydrate onset temperature. This temperature represents the initiation point of hydrate nucleation and was measured three times.

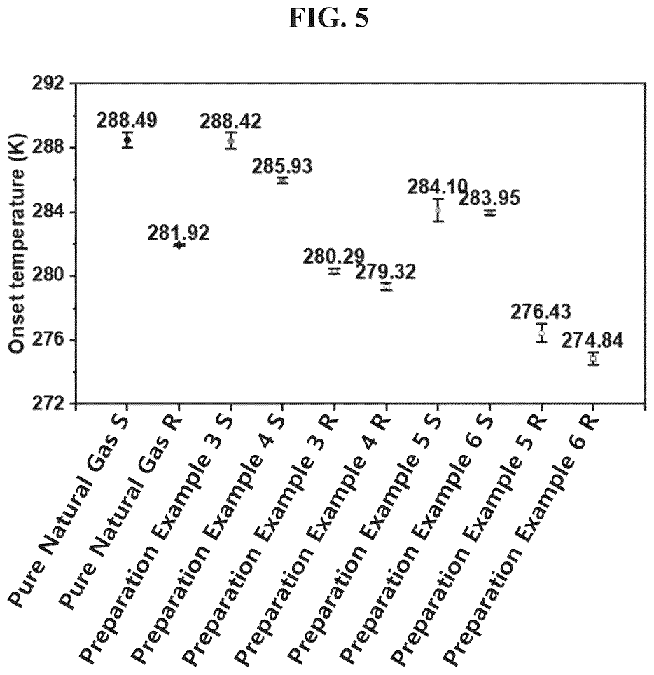

The results are presented in Table 1 and FIG. 5.

TABLE 1

| | | | | Onset |
|---|---|---|---|---|
| Measurement | Grafting | Cooling | Inhibitor | Temperature |
| Example 2 | Density | Rate | (wt %) | (K) |
| Pure Natural Gas | — | Slow (S) | — | 288.49 (±0.46) |
| | | Rapid (R) | | 281.92 (±0.06) |
| Preparation Example 3 | 50% | Slow (S) | 1 | 288.42 (±0.51) |
| Preparation Example 4 | 50% | | 2 | 285.93 (±0.19) |
| Preparation Example 3 | 50% | Rapid (R) | 1 | 280.29 (±0.17) |
| Preparation Example 4 | 50% | | 2 | 279.32 (±0.22) |
| Preparation Example 5 | 100% | Slow (S) | 1 | 284.10 (±0.72) |
| Preparation Example 6 | 100% | | 2 | 283.95 (±0.15) |
| Preparation Example 5 | 100% | Rapid (R) | 1 | 276.43 (±0.60) |
| Preparation Example 6 | 100% | | 2 | 274.84 (±0.39) |

FIG. 5 is a graph showing the onset temperatures of hydrate formation for pure natural gas and the inhibitors according to the Preparation Examples of the present inventive concept.

Referring to FIG. 5, the onset temperature of hydrate formation for pure natural gas was 288.49 K under the slow cooling rate and 281.92 K under the rapid cooling rate, indicating that the onset temperature of hydrate formation decreases as the cooling rate increases.

For the inhibitor from Preparation Example 3, the onset temperature of hydrate formation was 288.42 K under the slow cooling rate and 280.29 K under the rapid cooling rate. For the inhibitor from Preparation Example 4, the onset temperature of hydrate formation was 285.93 K under the slow cooling rate and 279.32 K under the rapid cooling rate. The inhibitors from Preparation Examples 5 and 6 also exhibited the same trend.

The lower onset temperatures observed at more rapid cooling rates can be attributed to greater subcooling induced by rapid cooling compared to slow cooling.

According to the nucleation theory of gas hydrates, rapid cooling does not allow sufficient time for the system to reach thermodynamic equilibrium, resulting in nucleation occurring at lower temperatures.

Therefore, under the same grafting density and weight percent, the lower onset temperature of hydrate formation observed under the rapid cooling rate indicates enhanced kinetic inhibition performance.

Moreover, under the same cooling rate and weight percent, a higher grafting density resulted in a lower onset temperature of hydrate formation. Furthermore, under the same cooling rate and grafting density, a higher weight percent also resulted in a lower onset temperature of hydrate formation.

In conclusion, the gas hydrate inhibitor inhibits nucleation by adsorbing onto the surface of gas hydrates or nucleation sites.

As can be seen from the results of Preparation Example 6, a greater amount of inhibitor adsorbed onto the hydrate surface or nucleation sites increases the number of amide functional groups, which interfere with the hydrogen bonding required for gas hydrate cage formation, thereby inhibiting gas hydrate formation.

In other words, an increased cooling rate, higher grafting density, and higher concentration can each contribute to a lower onset temperature of hydrate formation, thereby resulting in effective inhibition of gas hydrate formation.

### Measurement Example 3: Evaluation of Long-Term Kinetic Inhibition Performance of the Gas Hydrate Inhibitors

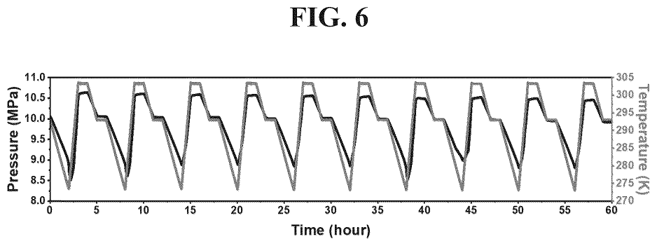

FIG. 6 is a graph evaluating the long-term kinetic inhibition performance of the gas hydrate inhibitor prepared according to an embodiment of the present inventive concept.

Referring to FIG. 6, the gas hydrate inhibitor prepared in Preparation Example 6 effectively inhibited natural gas hydrate formation over 10 cycles for 60 hours. The inhibition performance remained stable throughout the cycles, indicating its potential for repeated use without significant loss of effectiveness.

In particular, in some cycles, no sudden pressure drop was observed during cooling from 293.15 K to 273.15 K, suggesting that no hydrate formation occurred, thereby highlighting the potential of the gas hydrate inhibitor prepared in Preparation Example 6.

### Experimental Example: Verification of Magnetic Recovery of the Gas Hydrate Inhibitor

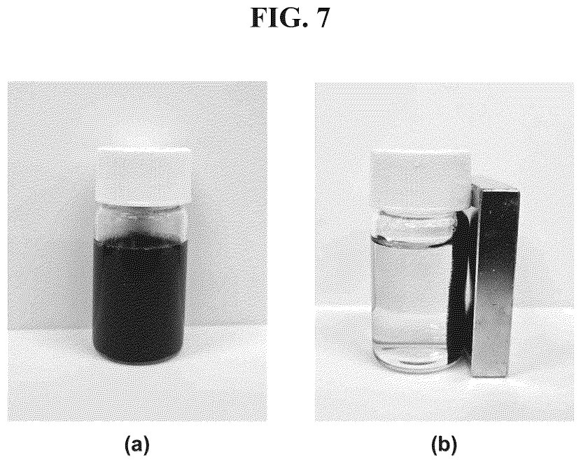

To verify whether the gas hydrate inhibitor can be magnetically recovered, a bar magnet was used in the experiment, and the results are shown in FIG. 7.

FIG. 7 shows that the gas hydrate inhibitor prepared according to an embodiment of the present inventive concept can be magnetically recovered.

As can be seen in FIGS. 7(a) and 7(b), the gas hydrate inhibitor was readily separated from the aqueous solution using a magnet. Such magnetic recoverability allows for easy and efficient recycling, thereby improving the practical applicability of the inhibitor. Accordingly, the gas hydrate inhibitor of the present inventive concept can be employed as an effective kinetic inhibitor.

According to the present inventive concept as described above, there are provided recoverable organic-inorganic hybrid nanoparticles, a gas hydrate inhibitor having the same, and a method for preparing the same. Through this, it is possible to provide a gas hydrate inhibitor that is effective at a low dosage and can be magnetically recovered.

While the inventive concept has been shown and described with reference to certain preferred embodiments thereof, it will be understood by those skilled in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

What is claimed is:

1. Recoverable organic-inorganic hybrid nanoparticles comprising:
magnetic nanoparticles;
silica coated on surface of the magnetic nanoparticles and having hydroxyl groups at terminal ends; and
an organosilyl sulfonic acid bonded to the hydroxyl groups of the silica through a hydrolysis reaction.

2. The nanoparticles according to claim 1, wherein the magnetic nanoparticles are Fe₃O₄ nanoparticles.

3. The nanoparticles according to claim 1, wherein the organosilyl sulfonic acid is selected from the group consisting of 3-(trihydroxysilyl)propanesulfonic acid, 3-(trimethoxysilyl)propanesulfonic acid, 3-(triethoxysilyl)propanesulfonic acid, and 4-(trimethoxysilyl)phenylmethanesulfonic acid.

4. A gas hydrate inhibitor comprising:
recoverable organic-inorganic hybrid nanoparticles comprising magnetic nanoparticles, silica coated on surface of the magnetic nanoparticles and having hydroxyl groups at terminal ends, and an organosilyl sulfonic acid bonded to the hydroxyl groups of the silica through a hydrolysis reaction; and
amine-terminated poly(N-isopropylacrylamide),
wherein hydroxyl groups of the organosilyl sulfonic acid and amine groups of the amine-terminated poly(N-isopropylacrylamide) form ionic bonding.

5. The gas hydrate inhibitor according to claim 4, wherein the magnetic nanoparticles are Fe₃O₄ nanoparticles.

6. The gas hydrate inhibitor according to claim 4, wherein the organosilyl sulfonic acid is selected from the group consisting of 3-(trihydroxysilyl)propanesulfonic acid, 3-(trimethoxysilyl) propanesulfonic acid, 3-(triethoxysilyl)propanesulfonic acid, and 4-(trimethoxysilyl)phenylmethanesulfonic acid.

7. The gas hydrate inhibitor according to claim 4, wherein the gas hydrate inhibitor is suspended in water at a concentration of 0.25 wt % to 3 wt %.

8. A method for preparing recoverable organic-inorganic hybrid nanoparticles, the method comprising the steps of:
synthesizing silica-coated magnetic nanoparticles;
dispersing the silica-coated magnetic nanoparticles in an aqueous solution to prepare a suspension;
adding an organosilyl sulfonic acid to the suspension;
adjusting pH of the suspension to which the organosilyl sulfonic acid has been added;
dialyzing the pH-adjusted suspension; and
treating the dialyzed suspension with a cation exchange resin.

9. The method according to claim 8, wherein the step of synthesizing the silica-coated magnetic nanoparticles comprises the steps of:
activating hydroxyl groups on surface of the magnetic nanoparticles;
adding ethanol, deionized water, and ammonia water to the magnetic nanoparticles having the activated hydroxyl groups, followed by a first ultrasonic treatment; and
adding a silica precursor and ethanol to the magnetic nanoparticles subjected to the first ultrasonic treatment, followed by a second ultrasonic treatment.

10. The method according to claim 9, wherein the activating hydroxyl groups has dispersing the magnetic nanoparticles in deionized water and performing a third ultrasonic treatment for the dispersed magnetic nanoparticles while introducing nitrogen (N₂).

11. The method according to claim 9, wherein the silica precursor is tetraethyl orthosilicate (TEOS).

12. The method according to claim 8, wherein the magnetic nanoparticles are Fe₃O₄ nanoparticles.

13. The method according to claim 8, wherein the organosilyl sulfonic acid is selected from the group consisting of 3-(trihydroxysilyl)propanesulfonic acid, 3-(trimethoxysilyl)propanesulfonic acid, 3-(triethoxysilyl)propanesulfonic acid, and 4-(trimethoxysilyl)phenylmethanesulfonic acid.

14. The method according to claim 8, wherein the pH is adjusted to 4.5 to 5.5.
